(19) United States
(12) Patent Application Publication
(10) Pub. No.: US 2008/0269981 A1
(43) Pub. Date: Oct. 30, 2008

(54) System and method for tracking and categorizing machine efficiency

(75) Inventors: Jason Pagnotta, Sahuarita, AZ (US); Steven Groth, Morton, IL (US); Ted Kingham, Metamora, IL (US); Kenneth Stratton, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/790,310

(22) Filed: Apr. 25, 2007

(51) Int. Cl. G06F 19/00

(52) U.S. Cl. 701/35

(57) ABSTRACT

A control system for a mobile excavation machine is disclosed. The control system may include a ground engaging work tool, a sensor and a controller. The sensor may be configured to sense a parameter indicative of a current operating condition of the mobile excavation machine and to generate a signal in response thereto. The controller may be in communication with the sensor and configured to receive the signal and calculate a current efficiency value based on the received signals. The controller may be further configured to associate the current efficiency value with a current operating mode of the machine and categorize and store the current efficiency value based on the current operating mode.

### TECHNICAL FIELD

The present disclosure relates generally to a system for monitoring machine efficiency and, more particularly, to a system and method for providing both real-time and categorized efficiency statistics to an operator of the machine.

### BACKGROUND

Machines such as, for example, dozers, motor graders, wheel loaders, and other types of heavy equipment are used to perform a variety of earth-moving tasks. Some of these tasks requiring removal of large amounts of material can be difficult for an unskilled or inexperienced operator to achieve efficiently. For example, an unskilled operator may attempt to remove a maximum amount of material during an excavation pass, but may only be able to do so at a very slow speed. Another unskilled operator may attempt to travel quickly, but may only be able to move a very small amount of material during each excavation pass at that speed. Finding the most productive combination of load and travel speed can be complicated, especially when manually performed by an inexperienced operator. Poor productivity and low efficiency can be costly to a machine owner. Because of these factors, it can be beneficial to provide the operator with an indication of machine performance so that corrections can be made to maximize efficiency.

One method of providing an operator with machine efficiency information is described in U.S. Pat. No. 7,039,507 (the '507 patent) issued to Hagenbuch on May 2, 2006. The '507 patent describes a machine monitoring system for providing the operator of a vehicle with a real-time indication of the efficiency of the vehicle in performing an assigned task. The '507 patent includes a processor on-board the vehicle, which monitors sensors that provide information regarding the health of the machine and an amount of work done by the machine. After obtaining the vehicle information, the processor relays to the operator a real-time efficiency of the vehicle. By informing the operator of a current efficiency, operation of the construction machine may be improved in a cost-effective manner.

Although the machine monitoring system of the '507 patent may be capable of informing an operator of real-time machine efficiency, its use may be limited. For example, though it may provide the operator with real-time efficiency data, it may not categorize the data or provide historical data for review and analysis at a later date. That is, because the machine monitoring system does not categorize the performance data based on operator-defined characteristics, the operator may be unable to determine his overall efficiency in a certain machine mode during a particular work assignment or recognize operational differences between excavation passes having different efficiencies.

The disclosed system is directed to overcoming one or more of the problems set forth above.

### SUMMARY OF THE INVENTION

In one aspect, the present disclosure is directed to a control system for a mobile excavation machine. The control system may include a ground engaging work tool, a sensor, and a controller. The sensor may be configured to sense a parameter indicative of a current operating condition of the mobile excavation machine and to generate a signal in response thereto. The controller may be in communication with the sensor and configured to receive the signal and calculate a current efficiency value based on the received signal. The controller may be further configured to associate the current efficiency value with a current operating mode of the machine and categorize and store the current efficiency value based on the current operating mode.

In another aspect, the present disclosure is directed to a method of tracking machine efficiency. The method may include receiving data indicative of current machine operation and calculating a current efficiency value based on the received data. The method may further include associating the current efficiency value with a current operating mode, and categorizing and storing the current efficiency value according to the current operating mode.

### BRIEF DESCRIPTION OF THE DRAWINGS

FIG. 1 is a pictorial illustration of an exemplary disclosed machine operating at a worksite;

FIG. 2 is a diagrammatic illustration of an exemplary disclosed control system for use with the machine of FIG. 1; and

FIG. 3 is an efficiency bar graph generated by the control system of FIG. 2.

### DETAILED DESCRIPTION

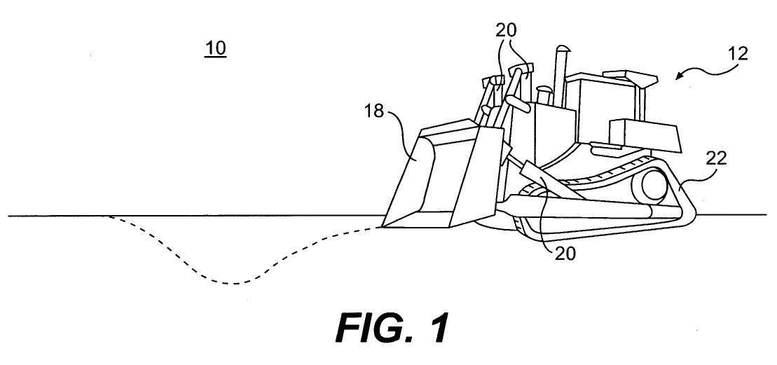

FIG. 1 illustrates a worksite 10 with an exemplary machine 12 performing a predetermined task. Worksite 10 may include, for example, a mine site, a landfill, a quarry, a construction site, or any other type of worksite. The predetermined task may be associated with altering the current geography at worksite 10 and may include, for example, a grading operation, a scraping operation, a leveling operation, a bulk material removal operation, or any other type of geography altering operation at worksite 10.

Machine 12 may embody a mobile machine that performs some type of operation associated with an industry such as mining, construction, farming, or any other industry. For example, machine 12 may be an earth moving machine such as a dozer having a blade or other work implement 18 movable by way of one or more motors or cylinders 20. Machine 12 may also include one or more traction devices 22, which may function to steer and/or propel machine 12.

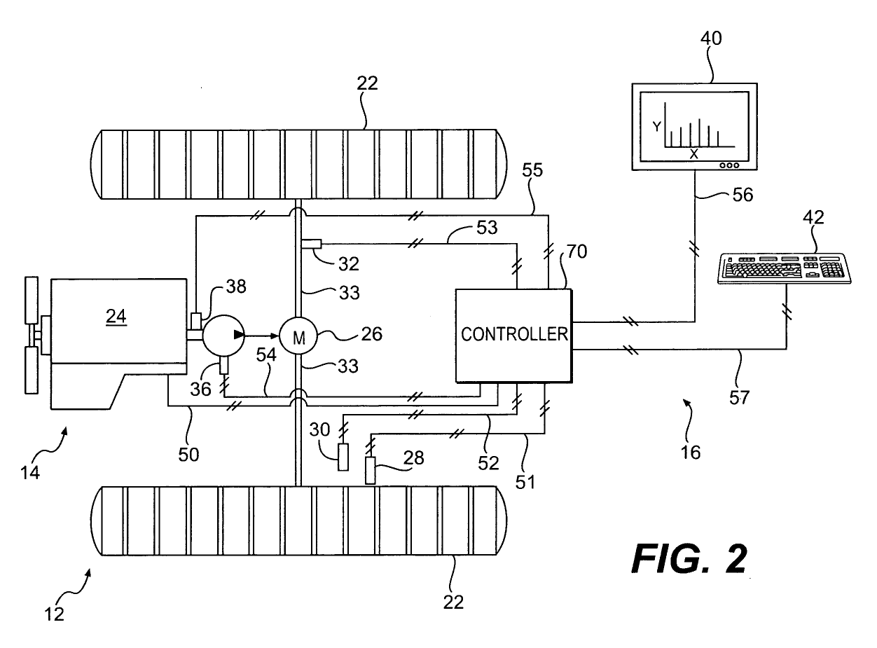

As best illustrated in FIG. 2, machine 12 may include a power unit 14 to affect the operation of machine 12. Power unit 14 may include a power source 24 and a transmission 26 coupling power source 24 to traction devices 22.

Power source 24 may embody an internal combustion engine such as, for example, a diesel engine, a gasoline engine, a gaseous fuel powered engine, or any other type of engine apparent to one skilled in the art. Power source 24 may alternatively or additionally include a non-combustion source of power such as a fuel cell, a power storage device, an electric motor, or other similar mechanism. Power source 24 may be connected to transmission 26 via a direct mechanical coupling, an electric or hydraulic circuit, or in any other suitable manner.

Transmission 26 may include a pump such as a variable or fixed displacement hydraulic pump drivably connected to power source 24. Transmission 26 may produce a stream of pressurized fluid directed to a motor M associated with at least one traction device 22 to drive the motion thereof. Alternatively or additionally, transmission 26 could include a generator configured to produce an electrical current used to drive a motor associated with any one or all of traction devices 22, a mechanical transmission device, or any other appropriate means known in the art.

Machine 12 may also include a control system 16 in communication with components of machine 12 and power unit 14 to monitor and affect the operation of machine 12. In particular, control system 16 may include a ground speed sensor 28, an inclinometer 30, a torque sensor 32, a pump pressure sensor 36, an engine speed sensor 38, an operator display device 40, an operator interface device 42, and a controller 70. Controller 70 may be in communication with power source 24, ground speed sensor 28, inclinometer 30, torque sensor 32, pump pressure sensor 36, engine speed sensor 38, operator display device 40, and operator interface device 42 via communication links 50-57, respectively.

Speed sensor 28 may be associated with machine 12 to determine a ground speed of machine 12. For example, speed sensor 28 may embody an electronic receiver that communicates with one or more satellites (not shown) or a local radio or laser transmitting system to determine a relative location and speed of itself. Speed sensor 28 may receive and analyze high-frequency, low power radio or laser signals from multiple locations to triangulate a relative 3-D position and speed. Speed sensor 28 may also, or alternatively, include a ground-sensing radar system to determine the travel speed of machine 12. Alternatively, speed sensor 28 may embody an Inertial Reference Unit (IRU), a position sensor associated with traction device 22, or any other known locating and speed sensing device operable to receive or determine positional information associated with machine 12. A signal indicative of this position and speed may be communicated from speed sensor 28 to controller 70 via communication link 51.

Inclinometer 30 may be a grade detector associated with machine 12 and may continuously detect an inclination of machine 12. In one exemplary embodiment, inclinometer 30 may be associated with or fixedly connected to a frame of machine 12. However, inclinometer 30 may be located on any stable surface of machine 12. In one exemplary embodiment, inclinometer 30 may detect incline in any direction, including a forward-aft direction, and responsively generate and send an incline signal to controller 70 via communication link 52. It should be noted that although this disclosure describes inclinometer 30 as the grade detector, other grade detectors may be used. In one exemplary embodiment, the grade detector may include two GPS receivers, with one stationed at each end of the machine 12. By knowing the positional difference of the receivers, the inclination of machine 12 may be calculated. Other grade detectors also may be used.

Torque sensor 32 may be operably associated with transmission 26 to directly sense torque output and/or torque output speed of transmission 26. It is contemplated that alternative techniques for determining torque output may be implemented such as monitoring various parameters of machine 12 and responsively determining a value of output torque from transmission 26, or by monitoring a torque command sent to transmission 26. For example, engine speed, torque converter output speed, transmission output speed, and other parameters may be used, as is well known in the art, to compute output torque from transmission 26. Torque sensor 32 may send to controller 70 via communication link 53 a signal indicative of the torque output and/or torque output speed of transmission 26.

Pump pressure sensor 36 may be mounted to transmission 26 to sense the pump pressure. In particular, pump pressure sensor 36 may embody a strain gauge-type sensor, a piezoresistive type pressure sensor, or any other type of pressure sensing device known in the art. Pump pressure sensor 36 may generate a signal indicative of the pump pressure and send this signal to controller 70 via communication link 54.

Engine speed sensor 38 may be operably associated with power source 24 of machine 12 to detect the speed of power source 24. In one exemplary embodiment, engine speed sensor 38 may measure the rotations per minute (rpm) of an output shaft or cam shaft. Engine speed sensor 38 may be associated with other components that allow measuring or determining of the speed of the power source.

Operator display device 40 may include a display stationed proximate the operator to reflect the status and/or performance of machine 12 or systems or components thereof to the operator. Display device 40 may be one of a liquid crystal display, a CRT, a PDA, a plasma display, a touch-screen, a monitor, a portable hand-held device, or any other display known in the art.

Operator interface device 42 may enable an operator of machine 12 to interact with controller 70. Operator interface device 42 may comprise a keyboard, steering wheel, joystick, mouse, touch screen, voice recognition software, or any other input device known in the art to allow an operator to interact with controller 70. Interaction may include operator requests for specific categorized information from controller 70 to be displayed via operator display device 40. For example, the operator may request performance data categorized relative to a carry mode or a load mode of machine 12 be displayed via display device 40.

Controller 70 may include means for monitoring, recording, storing, indexing, processing, determining, and/or communicating the information provided by ground speed sensor 28, inclinometer 30, torque sensor 32, pump pressure sensor 36, engine speed sensor 38, and any other information available from the various components of machine 12. These means may include, for example, a memory, one or more data storage devices, a central processing unit, or any other components that may be used to run the disclosed application. Furthermore, although aspects of the present disclosure may be described generally as being stored in memory, one skilled in the art will appreciate that these aspects can be stored on or read from different types of computer program products or computer-readable media such as computer chips and secondary storage devices, including hard disks, floppy disks, optical media, CD-ROM, or other forms of RAM or ROM. Controller 70 may further communicate and/or display information to an operator of machine 12 via operator display device 40, and receive instructions and/or requests from an operator via operator interface device 42.

Controller 70 may determine the efficiency of machine 12 based on one or more inputs associated with the operational characteristics of machine 12. Specifically, efficiency may be a function of the ground speed provided by ground speed sensor 28, the inclination of machine 12 provided by inclinometer 30, the torque output provided by torque sensor 32, the pump pressure provided by pump sensor 36, and the engine speed provided by engine speed sensor 38. Controller 70 may also consider various informational aspects of machine 12 in determining an instantaneous efficiency, such as current gear ratio, current operating mode, and any other informational aspects that may enhance the accuracy of the efficiency computation. Efficiency may be a measure of forces and time with respect to a known optimal distribution of forces within a specified amount of time. For example, controller 70 may determine efficiency by comparing an amount of power produced to an amount of power transmitted to the ground (i.e., ground power). The Ground_Power of machine 12 may be calculated according to Eq. 1 below:

$$Ground\_Power = \frac{Ground\_Speed}{375} * [ \frac{Driveline\_Torque}{Sprocket\_Radius} - Weight * sin ( Slope ) - loss ] \qquad Eq . 1$$

wherein:
   Ground_Power is the current amount of power (in horsepower) being transmitted to the ground by machine 12;
   Ground_Speed is the current ground speed sensed by ground speed sensor 28;
   Driveline_Torque is a value dependent of upon the ratio of engine speed provided by engine speed sensor 38 and torque converter output speed measured by torque sensor 32 (Controller 70 may contain tables of empirically obtained data relating this ratio to a specific value of driveline torque);
   Sprocket_Radius is a geometrical constant specific to machine 12;
   Weight is a physical constant specific to machine 12;
   Slope is the current incline or decline of machine 12 at worksite 10 provided by inclinometer 30; and
   loss is a variable that accounts for track friction, rolling resistance, pump losses, load distributions, slippage, and any other known power loss.

Once controller 70 has determined the current Ground_Power of machine 12, controller 70 may additionally calculate a currently Produced_Power of machine 12. This produced power value may account for all power produced by power source 24, and may be obtained by monitoring fueling characteristics of power source 14 and/or utilizing stored maps and/or tables relating fueling characteristics and consumption to produced power. After determining both the current Ground_Power and a current Produced_Power, controller 70 may determine instantaneous efficiency η by taking a ratio thereof. Ground_Power to Produced_Power, according to Eq. 2 below.

$$η = \frac{Ground\_Power}{Produced\_Power} \qquad Eq . 2$$

wherein:
   η is the instantaneous efficiency of machine 12;
   Ground_Power is the current amount of power being transmitted to the ground as calculated by Eq. 1;
   Produced_Power is the current total power production of power source 24.

Alternatively, efficiency may be a comparison of, for example, the amount of material that machine 12 moves in a given interval of time (i.e., volume per time) while under manual operator control versus an optimal amount of material that machine 12 could move. It is also contemplated that the efficiency may be determined by other methods of calculating or approximating the work performed by the machine 12 within a time period or cost per amount of work done.

Controller 70 may display, via operator display device 40, the instantaneous efficiency of machine 12 to an operator. Operator display device 40 may display the instantaneous efficiency in numerical form, graphical form, or any other form capable of communicating the efficiency information to the operator. The operator of machine 12 may use this instantaneous efficiency information to alter the current method of operation to increase the instantaneous efficiency. For example, while carrying a load of material across worksite 10, controller 70 may determine that machine 12 is operating at a less than optimal efficiency. This suboptimal performance may be due to an excessive ground speed, a low ground speed, an inappropriate gear ratio, an under or oversized load, slip caused by excessive torque, or any other condition that may cause machine 12 to operate at a less than optimal efficiency.

Controller 70 may further record, compare, and/or organize data relating to the efficiency of machine 12 while operating in different operating modes. Examples of different operating modes may include, a load mode, a carry mode, a dump/spread mode, and/or a return mode. Each operating mode may indicate a unique and discrete set of circumstances such that no two operating modes may be simultaneously present. In this way, controller 70 may further record, determine, and/or analyze a change in efficiency with respect to the mode of machine 12 by associating each piece of efficiency data with mode data. Mode data may correspond to the operating mode in which machine 12 is operating when the particular piece of performance data is recorded. For example, an operator may make twenty passes at worksite 10, each pass including a load mode, a carry mode, a dump mode, and a return mode. Controller 70 may evaluate and display the instant efficiency throughout the workshift, and it may also categorize and record the efficiency data. Controller 70 may categorize the data according to the associated current operating mode. Upon completion of a shift, an operator of machine 12 may, via operator interface device 42, instruct controller 70 to display on operator display device 40 the stored efficiency data with respect to certain mode data. For instance, an operator may instruct controller 70 to display the stored efficiency data relating to the carry modes performed during the preceding shift. Controller 70 may then access the recorded data which corresponds to the requested mode data (i.e., the stored efficiency data associated with a carry mode).

Controller 70 may determine current operating mode from a manual indication of an operator via operator interface device 42. For example, operator interface device 42 may contain buttons or any other method of indicating to controller 70 the intended operating mode. It is also contemplated that controller 70 may automatically determine current operating mode by receiving input from operator interface device 42 and analyzing the input. For example, operator interface device 42 may include one or more joysticks to control both machine 12 and work implement 18. As an operator of machine 12 manipulates operator interface device 42 to steer machine 12 around worksite 10 and to operate work implement 18 to alter the geography of worksite 10, operator interface device 42 may send the operating signals to controller 70. Controller 70 may then affect the operation of power source 24 accordingly to correspond with the requested manipulation. In addition to using the signals from operator interface device 42 to control machine 12 and work implement 18, controller 70 may further analyze the signals to automatically determine a machine operating mode. For example, when an operator uses operator interface device 42 to request a downward movement of work implement 18 into worksite 10, controller 70 may determine that machine 12 is in a load mode. Alternatively, if an operator requests work implement 18 to remain engaged with worksite 10 while requesting transmission 26 to propel traction devices 22, controller 70 may determine that machine 12 is in a spread mode. By analyzing the requested or measured location and orientation of work implement 18, the requested or measured pressures of cylinders 20, the requested or measured speed of traction devices 22, and/or the requested or measured parameters of any component of machine 12, controller 70 may automatically determine a current operating mode. Controller 70 may include appropriate hardware or software for performing such an analysis.

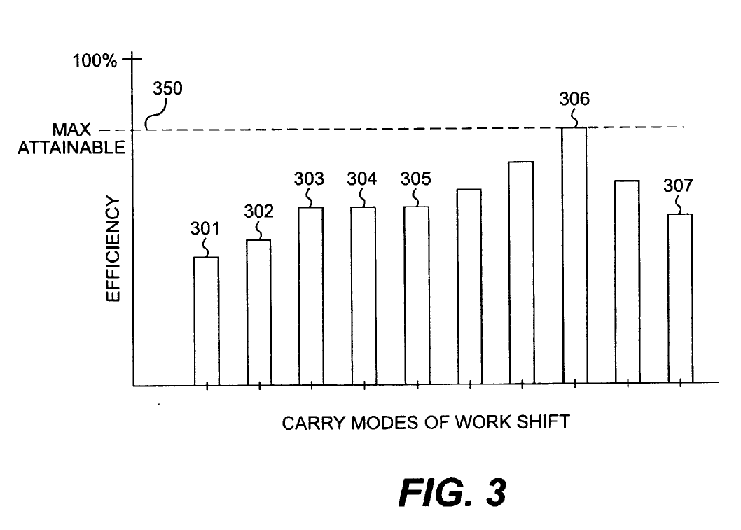

Controller 70 may display, via operator display device 40, the categorized efficiency data of machine 12 to an operator. Operator display device 40 may display the categorized efficiency data in numerical form, graphical form, or any other form capable of communicating the efficiency information to the operator. As seen in FIG. 3, the categorized efficiency data may be used to create a bar graph to indicate the historical efficiency of machine 12 with respect to selected categorization data. The operator of machine 12 may use this categorized data to evaluate and/or alter his method of operation to increase efficiency. For example, after carrying twenty loads of material across worksite 10, the operator may instruct controller 70 to display the categorized efficiency data associated with a carry mode. In response to the operator's request, controller 70 may recall the stored data that corresponds with the carry mode category and display the data. Such data may indicate, for instance, that the operator was more or less efficient during a particular segment of the workshift, and may suggest an operational adjustment that would maximize the efficiency during that segment. For example, controller 70 may indicate, through display device 40, that the latter part of the work shift contained less efficient carry modes than an earlier portion. This reduction in efficiency may be caused by machine 12 traveling with insufficient ground speed and/or attempting to carry too much material, or any other condition that may contribute to the inefficient operation of machine 12, which may be remedied by operator action.

FIG. 3 illustrates an exemplary plot of historical efficiency data from a work shift corresponding to a certain operating mode. In this example, categorized efficiency data relating to ten consecutive carry modes of a previous work shift of machine 12 are displayed. A first bar 301 may depict a suboptimal efficiency carry mode of machine 12 corresponding with the first carry operation performed during the work shift. A second bar 302 may depict increased efficiency corresponding with the second carry operation of the work shift. This increased efficiency from bar 301 to bar 302 may be the result of increased operator awareness, operator response to the currently displayed efficiency (as described above), or any other factor that may cause machine 12 to operate more efficiently. Additional bars 303, 304, and 305 may indicate the next three consecutive carry modes of machine 12 exhibiting substantially similar efficiencies that are each greater than the efficiency of bar 302, but still at a suboptimal efficiency when compared to a maximum attainable efficiency 350. Consecutive carry modes exhibiting substantially similar efficiencies may indicate than an operator of machine 12 is operating machine 12 is a fairly consistent manner. A sixth bar 306 may indicated a carry mode of machine 12 at a maximum efficiency level 350. This maximum efficiency carry mode may be the result of operator response to the displayed current efficiencies, increased operator experience with machine 12 and/or worksite 10, or any other factor enabling an operator of machine 12 to achieve a maximum machine efficiency. Bar 307 may indicate the last carry mode of the work shift performed by machine 12. A seventh bar 307 may indicate a suboptimal efficiency carry operation of machine 12, indicating a decrease in efficiency from bar 306. This decrease in efficiency could be caused by an operator attempting to carry too much or too little material, traveling too slow, lack of attention at the end of a long shift, or any other machine 12 condition that may decrease an overall efficiency of a given carry mode.

An operator of machine 12 may view a plot similar to FIG. 3 on operator display device 40 by requesting the information via operator interface device 42, as discussed above. Once the requested information is displayed, the operator may utilize the historical data to review his past work shift and improve future work shifts. For example, with reference to FIG. 3, an operator might observe that the efficiency of machine 12 increased from bar 301 to bar 302 and from bar 302 to 303. Based on this observation, an operator may recall a change in operation that would account for this increased efficiency, and incorporate that improved operation into future workshifts. Also, an operator may observe that the efficiency of machine 12 was consistent across bars 303-305. Here, the operator may recall a change in operation and realize it had little or no substantial effect on the overall efficiency, and apply that knowledge to future work shifts. Further, an operator may observe that in the eighth carry operation of the workshift, indicated by bar 306, the operator controlled machine 12 at a maximum efficiency level. As before, the operator may recall a certain mode or condition of operation that would explain the increased and optimal efficiency, and apply that knowledge to future workshifts. Lastly, an operator may observe that the last carry mode of the workshift, indicated by bar 307, was a decrease in efficiency from bar 306. Accordingly, the operator may recall a change in operating procedure that may account for the decreased efficiency (i.e., lower speed, carrying less) and apply that knowledge to future workshifts.

### INDUSTRIAL APPLICABILITY

The disclosed control system may be applicable to machines performing material moving operations where efficiency is important. In particular, the disclosed control system may determine a machine's current efficiency and also store and categorize the efficiency data for future retrieval and analysis. Because the control system may allow an operator to know both an instant machine efficiency and a historic machine efficiency categorized by mode data, the control system may be helpful in increasing operator and machine productivity. The operation of control system 16 will now be described.

Controller 70 may receive sensor and vehicle data as machine 12 begins work. Upon receiving sensor and vehicle data, controller 70 may determine current machine efficiency. Controller 70 may display the machine efficiency via operator display device 40 to inform the operator of the current machine efficiency with respect to an optimal efficiency.

In addition to displaying the machine efficiency, controller 70 may associate the current machine efficiency data with mode data, and categorize and store the data for later retrieval and review. For example, in addition to displaying the machine efficiency, controller 70 may store the current efficiency data and associate that data with mode data relating to the current operating mode (i.e., carry mode, load mode, dump/spread mode, return mode, etc.) of machine 12.

An operator of machine 12 may wish to view the categorized data with respect to a certain operating mode to affect his method of manual operation and achieve a more efficient result. To view this categorized and stored data, an operator may use operator input device 42 to request controller 70 to access and display efficiency data associated with a requested mode. For example, at the end of a work shift, an operator may wish to review the efficiency data associated by controller 70 with a return mode of machine 12. Since controller 70 may have previously associated all efficiency data with certain operating mode data, it may recall the efficiency data relating only to the requested operating mode, and display this categorized efficiency data via operator display device 40.

Because controller 70 may categorize and store efficiency data for later review, it may be helpful in evaluating a operator's manual control of machine 12. Specifically, since controller 70 may offer current efficiency data and historic efficiency data associated with various operating modes, an operator may be able to identify specific manual operation of machine 12 that are especially inefficient and respond accordingly.

It will be apparent to those skilled in the art that various modifications and variations can be made to the disclosed control system. Other embodiments will be apparent to those skilled in the art from consideration of the specification and practice of the disclosed control system. For example, it is contemplated that efficiencies may further be categorized and stored based on particular operators controlling machine 12, such that each operator may review their own work and/or compare their performance with the performance of another operator on the same machine at the same work site. It is intended that the specification and examples be considered as exemplary only, with a true scope being indicated by the following claims and their equivalents.

What is claimed is:

1. A control system for a mobile excavation machine, comprising:
a ground engaging work tool;
a sensor configured to sense a parameter indicative of a current operating condition of the mobile excavation machine and to generate a signal in response thereto; and
a controller in communication with the sensor, the controller being configured to:
receive the signal;
calculate a current efficiency value corresponding to a currently performed task based on the received signal;
associate the current efficiency value with a current operating mode of the machine; and
categorize and store the current efficiency value based on the current operating mode.

2. The control system of claim 1, further including an operator display device disposed within the mobile excavation machine, wherein the controller is further configured to display the current efficiency value on the operator display device.

3. The control system of claim 2, wherein the controller is further configured to:
receive a request to display the categorized efficiency values associated with a certain operating mode; and
display the categorized efficiency values associated with the certain operating mode on the operator display device.

4. The control system of claim 3, wherein the categorized efficiency values correspond to individual excavation passes completed during a single workshift.

5. The control system of claim 2, further including an operator interface device, wherein the controller is further configured to receive instructions from the operator interface device.

6. The control system of claim 5, wherein the operator interface device is used to manually communicate a current operating mode to the controller.

7. The control system of claim 1, wherein the current operating mode is automatically determined by the controller.

8. The control system of claim 1, wherein the sensor includes a ground speed sensor.

9. The control system of claim 7, further including:
an engine speed sensor;
an inclinometer; and
a torque sensor, wherein the current efficiency value is calculated based further on parameters measured by the engine speed sensor, inclinometer, and torque sensor.

10. A method of tracking machine efficiency, comprising:
receiving data indicative of current machine operation;
calculating a current efficiency value based on the received data,
associating the current efficiency value with a current operating mode; and
categorizing and storing the current efficiency value.

11. The method of claim 10, further including displaying the current efficiency value within a mobile earthmoving machine.

12. The method of claim 11, further including:
receiving a request to display stored efficiency values associated with a particular operating mode; and
displaying the requested efficiency values associated with the operating mode.

13. A mobile excavation machine, comprising:
a power source configured to generate a power output;
a traction device configured to receive the power output and propel the mobile excavation machine;
a ground engaging work tool;
a sensor configured to sense a parameter indicative of a current operating condition of the mobile excavation machine and to generate a signal in response thereto; and
a controller in communication with the sensor, the controller being configured to:
receive the signal;
calculate a current efficiency value corresponding to a currently performed task based on the received signal;
associate the current efficiency value with a current operating mode of the machine; and
categorize and store the current efficiency value based on the current operating mode.

14. The mobile excavation machine of claim 13, further comprising an operator display device disposed within the mobile excavation machine, wherein the controller is further configured to display the current efficiency value on the operator display device.

15. The mobile excavation machine of claim 14, the controller further configured to:
receive a request to display the categorized efficiency values associated with a certain operating mode; and
display the categorized efficiency values associated with the certain operating mode on the operator display device.

16. The mobile excavation machine of claim 15, further including an operator interface device, wherein the controller is further configured to receive instructions from the operator interface device.

17. The mobile excavation machine of claim 16, wherein the operator interface device is used to manually communicate a current operating mode to the controller.

18. The mobile excavation machine of claim 15, wherein the current operating mode is automatically determined by the controller.

19. The mobile excavation machine of claim 13, wherein the sensor includes a ground speed sensor, and the mobile excavation machine further includes:
an engine speed sensor;
a torque sensor; and
an inclinometer, wherein the current efficiency value is calculated based further on parameters measured by the ground speed sensor, engine speed sensor, inclinometer, and torque sensor.

20. The mobile excavation machine of claim 15, wherein the categorized efficiency values correspond to individual excavation passes completed during a single workshift.
